(19) United States
(12) Patent Application Publication
(10) Pub. No.: US 2022/0351917 A1
(43) Pub. Date: Nov. 3, 2022

(54) LAMINATED POWER STORAGE ELEMENT

(71) Applicant: KAWASAKI MOTORS, LTD., Hyogo (JP)

(72) Inventor: Kazuya NISHIMURA, Hyogo (JP)

(73) Assignee: KAWASAKI MOTORS, LTD., Hyogo (JP)

(21) Appl. No.: 17/863,750

(22) Filed: Jul. 13, 2022

Related U.S. Application Data
(63) Continuation of application No. PCT/JP2020/001341, filed on Jan. 16, 2020.

(51) Int. Cl. H01G 11/28; H01G 11/74

(52) U.S. Cl. CPC H01G 11/28; H01G 11/74

(57) ABSTRACT

Provided is a laminated power storage element including: an electrode member including a plurality of positive and negative electrode bodies each having a sheet shape and separators, the plurality of positive electrode bodies and the plurality of negative electrode bodies arranged so as to individually face each other, and the separators interposed between the individual electrode bodies; a plurality of positive electrode collectors connected to the plurality of positive electrode bodies; a plurality of negative electrode collectors connected to the plurality of negative electrode bodies; a positive electrode-side terminal to which the respective positive electrode collectors are connected; and a negative electrode-side terminal to which the respective negative electrode collectors are connected, wherein on at least one terminal of the positive electrode-side terminal and the negative electrode-side terminal, connection parts to which corresponding collectors are connected are arranged in a spatially distributed manner.

### CROSS REFERENCE TO THE RELATED APPLICATION

This application is a continuation application, under 35 U.S.C. § 111(a), of international application No. PCT/JP2020/001341, filed Jan. 16, 2020, the entire disclosures of all of which are herein incorporated by reference as a part of this application.

### BACKGROUND OF THE INVENTION

### Field of the Invention

The present invention relates to a laminated power storage element including a laminated electrode member.

### Description of Related Art

Patent Document 1 discloses a power storage element including a laminated electrode member which includes a plurality of sheet-like positive electrode bodies and a plurality of sheet-like negative electrode bodies, with separators interposed between the individual electrode bodies. The electrode member disclosed in Patent Document 1 includes a plurality of collectors individually connected to the plurality of sheet-like positive electrode bodies (or negative electrode bodies). The plurality of collectors are constructed such that they are gathered in an overlapping manner and are connected to a positive electrode-side terminal (or negative electrode-side terminal) at a single point by wielding or the like.

### RELATED DOCUMENT

### Patent Document

[Patent Document 1] JP Laid-open Patent Publication No. 2014-229435

### SUMMARY OF THE INVENTION

An electronic element may experience greater temperature rise when electric current is outputted from the element.

An object of the present invention is to provide a laminated power storage element with suppressed temperature rise in order to solve the above problem.

In order to achieve the above object, a laminated power storage element according to the present invention includes: an electrode member including a plurality of positive electrode bodies each having a sheet shape, a plurality of negative electrode bodies each having a sheet shape, and separators, the plurality of positive electrode bodies and the plurality of negative electrode bodies arranged so as to individually face each other, and the separators interposed between the individual positive electrode bodies and the individual negative electrode bodies;

a plurality of positive electrode collectors individually connected to the plurality of positive electrode bodies;

a plurality of negative electrode collectors individually connected to the plurality of negative electrode bodies;

a positive electrode-side terminal to which the respective positive electrode collectors are connected; and

a negative electrode-side terminal to which the respective negative electrode collectors are connected,

wherein on at least one terminal of the positive electrode-side terminal and the negative electrode-side terminal, connection parts in which corresponding collectors are connected are arranged in a spatially distributed manner.

According to this constitution, the distributed arrangement of the plurality of connection parts between the terminal(s) and the positive and/or negative electrode collectors makes it possible to avoid concentration of electric current in the connection parts. Consequently, it is possible to prevent temperature rise due to concentration of electric current flowing through local parts with high electrical resistance, that is, the connection parts inside the element and to suppress temperature rise transmitted from the collectors to the entire element.

The laminated power storage element may be, for example, an element constructed as a capacitor including an electrode on which an electrical double layer is to be formed. According to this constitution, more electric current can flow instantaneously than in a chemical battery. Even in this case, the above constitution still makes it possible to reduce the influence of heat generation and to facilitate flow of relatively large electric current.

Preferably, on both of the positive electrode-side terminal and the negative electrode-side terminal, corresponding collectors may be connected in connection parts arranged in a spatially distributed manner in that a greater effect can be obtained in terms of suppression of heat generation.

In the laminated power storage element according to one embodiment of the present invention, the laminated power storage element may include a bonded member made of an insulation resin material and constituting an outer body of the power storage element that covers the electrode member, the positive electrode collectors, and the negative electrode collectors; each of the positive electrode-side terminal and the negative electrode-side terminal may include a covered part covered by the bonded member and to which the positive electrode collectors or the negative electrode collectors are connected, and an exposed part exposed out of the bonded member; and the connection parts on the at least one terminal may be distributed in a direction perpendicular to a lamination direction of the electrode member. According to this constitution, it is possible to effectively suppress temperature rise in the element interior of the power storage element of a so-called laminate type suitable for a thin structure.

In the laminated power storage element according to one embodiment of the present invention, the connection parts may be distributed in a lead-out direction in which the covered part and the exposed part are juxtaposed. According to this constitution, it is possible to suppress heat generation in the lead-out direction of the positive electrode-side terminal and the negative electrode-side terminal.

In the laminated power storage element according to one embodiment of the present invention, the at least one terminal may have a larger dimension in a widthwise direction perpendicular to the lead-out direction and a thickness direction than a dimension in the lead-out direction in which the covered part and the exposed part are juxtaposed, and the connection parts may be distributed in the widthwise direction. According to this constitution, it is possible to suppress heat generation in the connection parts while avoiding increase in the dimension in the lead-out direction.

In the laminated power storage element according to one embodiment of the present invention, each collector of at least either the positive electrode collectors or the negative electrode collectors may include a base part to be connected to the electrode member and a protruding part protruding from the base part to be connected to the positive electrode-side terminal or the negative electrode-side terminal; and the protruding part may be shaped such that the protruding part has, at least in a portion adjacent to the base part, a gradually decreasing dimension in a widthwise direction perpendicular to a protrusion direction and a thickness direction of the protruding part as the protruding part extends away from the base part. According to this constitution, it is possible to suppress concentration of electric current in the corner portions connecting the base part to the protruding part of each collector so as to suppress heat generation in these portions.

The present invention encompasses any combination of at least two features disclosed in the claims and/or the specification and/or the drawings. In particular, any combination of two or more of the appended claims should be equally construed as included within the scope of the present invention.

### BRIEF DESCRIPTION OF THE DRAWINGS

The present invention will be more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like or corresponding parts throughout the several views. In the figures,

FIG. 1 is a vertical section view showing a schematic structure of a laminated power storage element according to one embodiment of the present invention;

FIG. 2A schematically shows a connection structure of a comparative example in order to illustrate the advantages of the laminated power storage element of FIG. 1;

FIG. 2B schematically shows a connection structure of a present example in order to illustrate the advantages of the laminated power storage element of FIG. 1;

FIG. 3 is a plan view showing a variant of the power storage element of FIG. 1; and

FIG. 4 is a plan view showing a positive electrode collector of the power storage element of FIG. 1 in an enlarged manner.

### DESCRIPTION OF THE EMBODIMENTS

Hereinafter, an embodiment according to the present invention will be described with reference to the drawings. The present invention, however, is not intended to be limited to this embodiment.

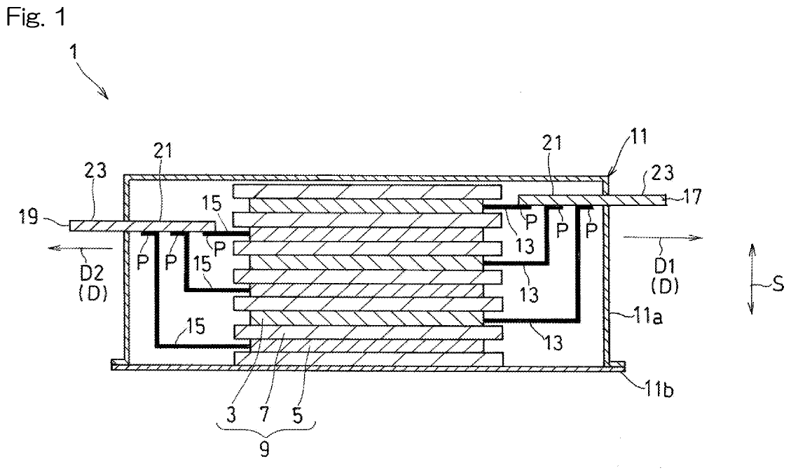

FIG. 1 is a section view which schematically shows the structure of a laminated power storage element (hereinafter, simply referred to as “power storage element”) 1 according to one embodiment of the present invention. The power storage element 1 is constructed as a lithium-ion capacitor which contains a material forming an electrical double layer by physical adsorption and desorption of ions (activated carbon in this example) as a major positive electrode active material, a material capable of adsorbing and desorbing lithium ions by chemical reaction (graphite in this example) as a major negative electrode active material, and a non-aqueous solution as an electrolyte.

The power storage element 1 includes an electrode body 9 including a plurality of positive electrode bodies 3 each having a sheet shape, a plurality of negative electrode bodies 5 each having a sheet shape, and separators 7 each having a sheet shape, the plurality of positive electrode bodies and the plurality of negative electrode bodies arranged so as to individually face each other, and the separators interposed between the individual positive electrode bodies 3 and the individual negative electrode bodies 5. Specifically, in the present embodiment, the plurality of separators are arranged in a lamination direction, and the positive electrode bodies and the negative electrode bodies are alternately arranged between these separators in the lamination direction. Each of the separators, the positive electrode bodies, and the negative electrode bodies has a rectangular sheet shape when viewed in the lamination direction. During a charging process, lithium ions are adsorbed on the negative electrode active material applied to the negative electrode bodies in the negative electrode, and anions in the electrolyte are adsorbed on the positive electrode active material applied to the positive electrode bodies in the positive electrode. During a discharging process, the lithium ions are desorbed from the negative electrode active material in the negative electrode and are released into the electrolyte, and the anions are desorbed from the positive electrode active material in the positive electrode and are released into the electrolyte.

The electrode member 9 is received in an outer body 11 along with the electrolyte. In the present embodiment, the outer body 11 is made of an insulation resin material and includes bonded members 11a, 11b which cover positive electrode collectors 13 and negative electrode collectors 15 as described later. More specifically, the bonded members 11a, 11b are constituted by aluminum laminate films each including an aluminum foil and synthetic resin films arranged on opposite sides of the aluminum foil.

In this example, each of the positive electrode bodies 3 has a sheet form including a substrate made of a metal foil containing aluminum as a major component and the above-mentioned positive electrode active material applied thereto. In this example, each of the negative electrode bodies 5 has a sheet form including a substrate made of a metal foil containing copper as a major component and the above-mentioned negative electrode active material applied thereto. Each of the plurality of positive electrode bodies 3 is electrically connected to one positive electrode collector 13. In other words, each positive electrode body 3 is provided with a positive electrode collector 13. Likewise, each of the plurality of negative electrode bodies 5 is electrically connected to one negative electrode collector 15. In other words, each negative electrode body 5 is provided with a negative electrode collector 15.

The positive electrode collectors 13 are connected to substrates of the positive electrode bodies 3, and the negative electrode collectors 15 are connected to substrates of the negative electrode bodies 5. Each positive electrode collector 13 is connected to a side edge part which forms a side of a rectangular positive electrode body 3. Each positive electrode collector 13 is arranged so as to be substantially parallel to the substrate to which that positive electrode collector 13 is connected and so as to protrude in a direction substantially perpendicular to the side edge part to which that positive electrode collector 13 is connected. The plurality of positive electrode collectors 13 are arranged at substantially equal intervals along the side edge parts to which the positive electrode collectors 13 are connected. Each negative electrode collector 15 is connected to a side edge part which forms a side of a rectangular negative electrode body 5 and is located opposite to the respective side edge parts to which the positive electrode collectors 13 are connected in a plan view. Each negative electrode collector 15 is arranged so as to be substantially parallel to the substrate to which that negative electrode collector 15 is connected and so as to protrude in a direction substantially perpendicular to the side edge part to which that negative electrode collector 15 is connected. The plurality of negative electrode collectors are arranged at substantially equal intervals along the side edge parts to which the negative electrode collectors 15 are connected. The positive electrode collectors 13 and the negative electrode collectors 15 having such configurations are received inside the outer body 11 as a whole.

The plurality of positive electrode collectors 13 are electrically connected to a common positive electrode-side terminal 17. The plurality of negative electrode collectors 15 are electrically connected to a common negative electrode-side terminal 19. The connections between the respective positive electrode collectors 13 and the positive electrode-side terminal 17 and the connections between the respective negative electrode collectors 15 and the negative electrode-side terminal 19 are formed, for example, by ultrasonic welding. The connections between the collectors 13, 15 and the terminals 17, 19, however, may be formed by other processes such as laser welding, spot welding, etc.

The positive electrode-side terminal 17 is connected to the plurality of positive electrode collectors 13 on the inner side of the outer body 11 (hereinafter, sometimes simply referred to as “element interior”). The positive electrode-side terminal 17 extends from connection parts P, where the respective positive electrode collectors 13 are connected, to the outside of the outer body 11 (hereinafter, sometimes simply referred to as “element exterior”). Likewise, the negative electrode-side terminal 19 is connected to the plurality of negative electrode collectors 15 in the element interior. The negative electrode-side terminal 19 extends from connection parts P, where the respective negative electrode-side collectors are connected, to the element exterior.

In other words, each of the positive electrode-side terminal 17 and the negative electrode-side terminal 19 includes a covered part 21 which is covered by the bonded members and to which the positive electrode collectors 13 or the negative electrode collectors 15 are connected, and an exposed part 23 which is exposed out of the bonded members. In the present specification, a “lead-out direction D” refers to a direction in which the covered part 21 and the exposed part 23 are juxtaposed, i.e., a direction in which the positive electrode-side terminal 17 and the negative electrode-side terminal 19 extend from the element interior to be led out of the element exterior. When lead-out directions on the positive electrode side and on the negative electrode side are distinguished in the description, the terms “first lead-out direction D1” and “second lead-out direction D2” may sometimes be used to indicate the lead-out direction D on the positive electrode side and the lead-out direction D on the negative electrode side, respectively. The lead-out direction D corresponds to the direction in which the collectors 13, 15 protrude as described above. Therefore, in the present embodiment, the first lead-out direction D1 and the second lead-out direction D2 extend opposite to each other from the side edge parts on the opposite sides of the rectangular electrode member.

The following describes the connection structure between the positive electrode-side terminal 17 and the plurality of positive electrode collectors 13 and the connection structure between the negative electrode-side terminal 19 and the plurality of negative electrode collectors 15. Since the connection structures between the terminal and the collectors are substantially the same on the positive electrode side and on the negative electrode side, the connection structure on the positive electrode side will be described below as a representative.

In the present embodiment, the connection parts P of the plurality of positive electrode collectors 13 are arranged so as to be spatially distributed on the positive electrode-side terminal 17. In other words, the plurality of positive electrode collectors 13 are connected to the positive electrode-side terminal 17 in such a way that all the positive electrode collectors 13 do not overlap in a single position. In the illustrated example, the connection parts P are distributed in a direction perpendicular to the lamination direction S of the electrode member 9.

More specifically, in this example, the connection parts P are distributed in the lead-out direction D. Particularly, the plurality of positive electrode collectors 13 have increasing dimensions in the lead-out direction D in the order from the positive electrode collector 13 located closest to the positive electrode-side terminal 17 to the positive electrode collector 13 located most apart from the positive electrode-side terminal. The respective positive electrode collectors 13 having such configurations are connected to the positive electrode-side terminal 17 in the corresponding parts P distributed along the lead-out direction D.

According to this constitution, heat generation due to concentrated flow of electric current in the connection parts is suppressed as compared with a case where the plurality of positive electrode collectors 13 are connected at a single position on the positive electrode-side terminal 17, so that heat generation in the lead-out direction D of the positive electrode collector 13 can be suppressed. That is, the plurality of positive electrode collectors 13 produce different amounts of electric power, i.e., Joule heat depending on whether the collectors are connected to the positive electrode-side terminal 17 at a single position (as in Comparative Example) or at distributed positions (as in Example), as described below.

### Comparative Example

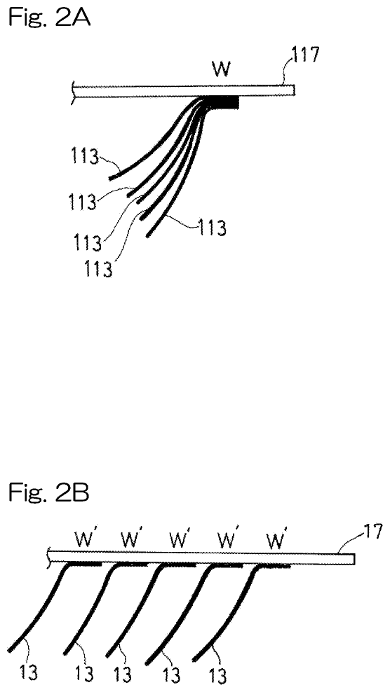

The connection parts have greater electrical resistance due to the contacts than that in other parts. In a case where a plurality of collectors 113 are connected to a terminal 117 in a single connection part in an overlapping manner as shown in FIG. 2A, electric current concentratedly flows to the single connection part. Assuming that five collectors 113 each conducting electric current of 10 A converge in a single connection part, electric power W can be calculated by W=RI² as follows:

W=R×(50)²=2500R.

### Example

In the Example as shown in FIG. 2B, five collectors 13 are connected to the terminal 17 in 5 points in a distributed manner, so that electric current flows through the connection parts in a distributed manner. Overall electric power W, which is the sum of electric power W′ in the individual connection parts can be calculated as follows:

W=5×W′=5×(R×10²)=500R.

Thus, the electric current can flow through the connection parts P in a distributed manner so as to suppress heat generation in the connection parts P. This can suppress heat transmitted from the connection parts P to the electrode member 9 through the collectors and thereby prevent the influence of heat generation in the electrode member 9.

Further, the respective positive electrode collectors 13 are connected to the positive electrode-side terminal 17 at different positions, so that connection failure can be prevented as compared with the case where the plurality of collectors 13 are connected in a single point. This can further reduce electrical resistance in the connection parts P.

In the present embodiment, the connection parts P are distributed on both of the positive electrode side and the negative electrode side. This construction makes it possible to prevent concentration of electric current in the connection parts P on both of the positive electrode side and the negative electrode side and thus to further prevent temperature rise.

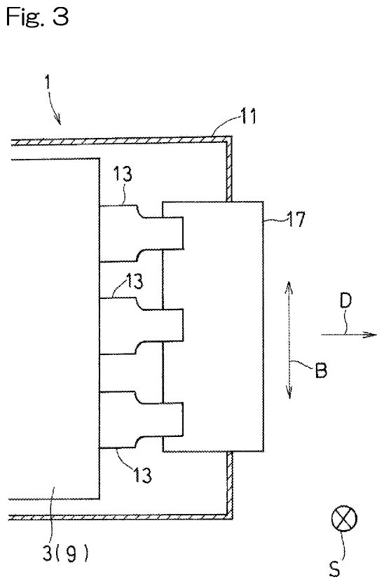

The distributed arrangement of the connection parts P in the direction perpendicular to the lamination direction S of the electrode member 9 is not limited to the above example. For instance, as shown in FIG. 3 as a variant, the respective connection parts P may be distributed in a widthwise direction 13 of the positive electrode-side terminal 17. As used herein, the “widthwise direction B” of the positive electrode-side terminal 17 refers to a direction perpendicular to the lead-out direction D and the lamination direction S.

More particularly, in the illustrated example, the positive electrode-side terminal 17 has a larger dimension in the widthwise direction B than its dimension in the lead-out direction D. The plurality of positive electrode collectors 13 are displaced with respect to one another in the widthwise direction B or, in other words, arranged at shifted positions so that their positions do not to overlap in the widthwise direction B. The respective positive electrode collectors 13 are connected at distributed positions along the widthwise direction B on the positive electrode-side terminal 17 having the above-described configuration. According to this constitution, it is possible to suppress heat generation in the connection parts P while avoiding increase in the dimension of the laminated power storage element 1 in the lead-out direction D due to extension of the positive electrode-side terminal 17 in the lead-out direction.

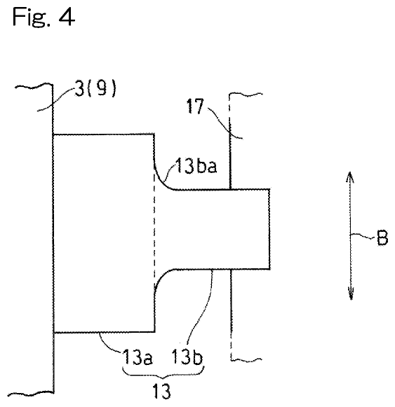

As shown in FIG. 4, in the present embodiment, each of the positive electrode collectors 13 includes a base part 13a to be connected to the electrode member 9 and a protruding part 13b protruding from the base part 13a to be connected to the positive electrode-side terminal 17. The protruding part 13b is shaped such that the protruding part 13b has, in a portion adjacent to the base part 13a, a gradually decreasing dimension in the widthwise direction B of the protruding part 13b as the protruding part extends away from the base part 13a. More specifically, the protruding part 13b has a smaller dimension in the widthwise direction than a dimension of the base part 13a in the widthwise direction and includes curved corner portions 13ba connecting from the base part 13a to the protruding part 13b.

This configuration can suppress concentration of electric current in the corner portions 13ba connecting the base part 13a to the protruding part 13b of each positive electrode collector 13 so as to suppress heat generation in these portions.

It is sufficient if the protruding part 13b is shaped to have, at least in a portion of the protruding part 13b adjacent to the base part 13a, the gradually decreasing dimension in the widthwise direction as the protruding part extends away from the base part 13a. However, the protruding part 13b may be formed in such a shape as a whole. Preferably, at least either the positive electrode collectors 13 or the negative electrode collectors 15 are formed in such shapes, and more preferably, all of the positive electrode collectors and the negative electrode collectors are formed in such shapes. It should be noted that the shape of a portion of the protruding part 13b adjacent to the base part 13a is not limited to the curved shape in the illustrated example and may be, for example, an inclined shape or a parabolic shape.

All the above examples have been described with reference to the case where the first lead-out direction D1 of the positive electrode-side terminal 17 is different from the second lead-out direction D2 of the negative electrode-side terminal 19. This configuration makes it easy to increase connecting areas along the widthwise direction B to reduce electrical resistance in the connection parts P. The first lead-out direction D1 and the second lead-out direction D2, however, may be an identical direction. That is, the positive electrode collectors 13 and the negative electrode collectors 15 may be provided to an identical side edge part of the rectangular electrode member 9 at mutually displaced positions along that side edge part, and the positive electrode-side terminal 17 and the negative electrode-side terminal 19 may be arranged so as to protrude in the lead-out direction D1, D2 at corresponding positions to the respective collectors 13, 15.

As described above, the connection positions P are preferably distributed on both of the positive electrode side and the negative electrode side. The connection parts P, however, may be distributed on only one of the positive electrode side and the negative electrode side.

All the above examples have been described with reference to the case where one collector is connected to a terminal in each connection part P. However, as long as a plurality of collectors are disturbed to at least two or more connection parts P, the effects of the connection structure according to the present embodiment can be obtained. That is, for example, in a case where four collectors are connected to a terminal in a distributed manner in two connection parts, with two collectors connected in each connection part, heat generation can be suppressed as compared with a case where all of the four collectors are connected to a terminal in a single connection part.

The present embodiment has been described with reference to the example where the power storage element 1 is a lithium-ion capacitor. However, the constitution of the present embodiment can be applied to, besides lithium-ion capacitors, a power storage element such as a capacitor which stores electrical charge by using an electrical double-layer electrode and a chemical battery (for example, a lithium-ion secondary battery).

The present embodiment has been described with reference to the example where the outer body 11 of the power storage element 1 is an aluminum laminate film. According to this constitution, it is possible to effectively suppress temperature rise in the element interior of the power storage element 1 of a so-called laminate type suitable for a thin structure. The outer body 11 of the power storage element 1, however, is not limited to an aluminum laminate film and may be, for example, a metal can.

As described above, according to the laminated power storage element 1 of the present embodiment, the plurality of connection parts P between the positive and/or negative electrode collectors 13, 15 and the terminals 17, 19 are distributed so as to avoid concentration of electric current in the connection parts P. Consequently, it is possible to prevent temperature rise due to concentration of electric current flowing through local parts with high electrical resistance, that is, the connection parts inside the element and to suppress temperature rise transmitted from the collectors 13, 15 to the entire power storage element 1. Further, by suppressing temperature rise inside the power storage element 1 in such a way, it is possible to suppress deterioration in output performance and decrease in life of the power storage element 1.

A laminated power storage element according to the present embodiment may be used in a portable device or an electric vehicle. In particular, the power storage element may be suitably used in an electrical instrument which requires relatively large instantaneous electric current. For example, the power storage element may be suitably used as a power source for an electrical instrument which requires relatively large instantaneous electric current, such as a saddle riding vehicle and a small planing boat which accelerate and decelerate in a relatively extensive manner. The power storage element may be suitably used as a power source for a multicopter (so-called drone) whose flight is controlled by individually controlling a plurality of rotor motors. Applications of a laminated power storage element according to the present embodiment are not limited to these examples.

Although the present invention has been described in terms of the preferred embodiments thereof with reference to the drawings, various additions, modifications, or deletions may be made without departing from the scope of the invention. Accordingly, such variants are included within the scope of the present invention.

### REFERENCE NUMERALS

1 . . . laminated power storage element
3 . . . positive electrode body
5 . . . negative electrode body
7 . . . separator
9 . . . electrode member
11 . . . outer body
11a, 11b . . . bonded member
13 . . . positive electrode collector
15 . . . negative electrode collector
17 . . . positive electrode-side terminal
19 . . . negative electrode-side terminal
21 . . . covered part
23 . . . exposed part
P . . . connection part

What is claimed is:

1. A laminated power storage element comprising:
an electrode member including a plurality of positive electrode bodies each having a sheet shape, a plurality of negative electrode bodies each having a sheet shape, and separators, the plurality of positive electrode bodies and the plurality of negative electrode bodies arranged so as to individually face each other, and the separators interposed between the individual positive electrode bodies and the individual negative electrode bodies;
a plurality of positive electrode collectors individually connected to the plurality of positive electrode bodies;
a plurality of negative electrode collectors individually connected to the plurality of negative electrode bodies;
a positive electrode-side terminal to which the respective positive electrode collectors are connected; and
a negative electrode-side terminal to which the respective negative electrode collectors are connected,
wherein on at least one terminal of the positive electrode-side terminal and the negative electrode-side terminal, connection parts to which corresponding collectors are connected are arranged in a spatially distributed manner.

2. The laminated power storage element as claimed in claim 1, wherein the laminated power storage element includes a bonded member made of an insulation resin material and constituting an outer body of the power storage element that covers the electrode member, the positive electrode collectors, and the negative electrode collectors;
each of the positive electrode-side terminal and the negative electrode-side terminal includes a covered part covered by the bonded member and to which the positive electrode collectors or the negative electrode collectors are connected, and an exposed part exposed out of the bonded member; and
the connection parts on the at least one terminal are distributed in a direction perpendicular to a lamination direction of the electrode member.

3. The laminated power storage element as claimed in claim 2, wherein the connection parts are distributed in a lead-out direction in which the covered part and the exposed part are juxtaposed.

4. The laminated power storage element as claimed in claim 2, wherein the at least one terminal has a larger dimension in a widthwise direction perpendicular to a lead-out direction and a thickness direction than a dimension in the lead-out direction in which the covered part and the exposed part are juxtaposed, and
the connection parts are distributed in the widthwise direction.

5. The laminated power storage element as claimed in claim 1, wherein the laminated power storage element is constructed as a capacitor including an electrode on which an electrical double layer is to be formed.

6. The laminated power storage element as claimed in claim 1, wherein on both of the positive electrode-side terminal and the negative electrode-side terminal, connection parts in which corresponding collectors are connected are arranged in a spatially distributed manner.

7. The laminated power storage element as claimed in claim 1, wherein each collector of at least either the positive electrode collectors or the negative electrode collectors includes a base part to be connected to the electrode member and a protruding part protruding from the base part to be connected to the positive electrode-side terminal or the negative electrode-side terminal, and
the protruding part is shaped such that the protruding part has, at least in a portion adjacent to the base part, a gradually decreasing dimension in a widthwise direction perpendicular to a protrusion direction and a thickness direction of the protruding part as the protruding part extends away from the base part.
